(19) United States
(12) Patent Application Publication
(10) Pub. No.: US 2025/0254399 A1
(43) Pub. Date: Aug. 7, 2025

(54) METHOD, APPARATUS, DEVICE, AND STORAGE MEDIUM FOR CONTENT INTERACTION

(71) Applicant: Beijing Youzhuju Network Technology Co., Ltd., Beijing (CN)

(72) Inventors: Fei Wang, Beijing (CN); Kai Hou, Beijing (CN); Jiahong Chen, Beijing (CN); Ziqiang Xie, Beijing (CN); Ge Zhou, Beijing (CN); Yuzhong Chen, Beijing (CN); Wei Cai, Beijing (CN); Xue Yao, Beijing (CN); Yunpeng Liang, Beijing (CN); Zhongwu Liao, Beijing (CN); Li Li, Beijing (CN); Haozhe Zhang, Beijing (CN)

(21) Appl. No.: 19/041,954

(22) Filed: Jan. 30, 2025

(30) Foreign Application Priority Data
Feb. 1, 2024 (CN) 202410145506.5

(51) Int. Cl. H04N 21/482

(52) U.S. Cl. CPC H04N 21/4826

(57) ABSTRACT

According to embodiments of the disclosure, a method, an apparatus, a device, and a storage medium for content interaction are provided. The method includes: in response to a content presentation indication, playing a first video clip associated with a recommended object; presenting a plurality of thumbnails in association with the first video clip, the plurality of thumbnails being linked to a plurality of video clips associated with the recommended object, respectively; and in response to detecting a selection of a second thumbnail in the plurality of thumbnails, playing a second video clip associated with the second thumbnail while maintaining presentation of at least one of the plurality of thumbnails. In this way, a user can be allowed to quickly switch and view other video clips by means of thumbnail selection while playing a video, thus providing more effective and convenient content browsing and interaction.

### CROSS REFERENCE

The application claims priority to Chinese Patent Application No. 202410145506.5, filed on Feb. 1, 2024, and entitled “METHOD, APPARATUS, DEVICE, AND STORAGE MEDIUM FOR CONTENT INTERACTION”, the entirety of which is incorporated herein by reference.

### FIELD

Example embodiments of the present disclosure generally relate to the field of computer technologies, and in particular, to a method, an apparatus, a device, and a computer-readable storage medium for content interaction.

### BACKGROUND

The Internet provides access to various kinds of content. For example, various kinds of images, audios, videos, web pages, and the like can be accessed through the Internet. In addition, the accessible content further includes specific content related to various types of object recommendation, such as video advertisements, text and image advertisements, and the like. In this way, users can browse content as needed to acquire more information and services that they are interested in.

### SUMMARY

In a first aspect of the present disclosure, a method for content interaction is provided. The method includes: in response to a content presentation indication, playing a first video clip associated with a recommended object; superimposing and presenting a plurality of thumbnails in association with the first video clip, the plurality of thumbnails being linked to a plurality of video clips associated with the recommended object, respectively; and in response to detecting a selection of a second thumbnail in the plurality of thumbnails, playing a second video clip associated with the second thumbnail while maintaining presentation of at least one of the plurality of thumbnails.

In a second aspect of the present disclosure, an apparatus for content interaction is provided. The apparatus includes: a first playing module configured to in response to a content presentation indication, play a first video clip associated with a recommended object; a thumbnail presenting module configured to present a plurality of thumbnails in association with the first video clip, the plurality of thumbnails being linked to a plurality of video clips associated with the recommended object, respectively; and a second playing module configured to in response to detecting a selection of a second thumbnail in the plurality of thumbnails, play a second video clip associated with the second thumbnail while maintaining presentation of at least one of the plurality of thumbnails.

In a third aspect of the present disclosure, an electronic device is provided. The device includes at least one processing unit; and at least one memory coupled to the at least one processing unit and storing instructions executable by the at least one processing unit. The instructions, when executed by the at least one processing unit, cause the device to perform the method of the first aspect.

In a fourth aspect of the present disclosure, a computer-readable storage medium is provided. The medium has a computer program stored thereon, and the computer program, when executed by a processor, implements the method of the first aspect.

It should be understood that the contents described in the Summary section are not intended to limit the key features or important features of the embodiments of the present disclosure, nor are they intended to limit the scope of the present disclosure. Other features of the present disclosure will become readily apparent from the following description.

### BRIEF DESCRIPTION OF THE DRAWINGS

The above and other features, advantages and aspects of various embodiments of the present disclosure will become more apparent when taken in conjunction with the drawings and with reference to the following detailed description. In the drawings, the same or similar reference numerals denote the same or similar elements, where:

FIG. 1 shows a schematic diagram of an example environment in which embodiments of the present disclosure can be implemented;

FIG. 2 shows a flowchart of a process for content interaction according to some embodiments of the present disclosure;

FIG. 3 shows a schematic diagram of an example page for content orchestrating according to some embodiments of the present disclosure;

FIG. 4A to FIG. 4B show schematic diagrams of interactions of an example page according to some embodiments of the present disclosure;

FIG. 5 shows a block diagram of an apparatus for content interaction according to some embodiments of the present disclosure; and

FIG. 6 shows an electronic device in which one or more embodiments of the present disclosure can be implemented.

### DETAILED DESCRIPTION

Embodiments of the present disclosure will be described in more detail below with reference to the drawings. Although some embodiments of the present disclosure are shown in the drawings, it should be understood that the present disclosure can be implemented in various forms, and should not be interpreted as being limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the scope of protection of the present disclosure.

In the description of the embodiments of the present disclosure, the term “comprise/include” and similar terms should be understood as open-ended inclusion, that is, “comprise/include but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below.

It can be understood that data involved in the technical solution of the present disclosure (including but not limited to the data itself, acquisition or use of the data) should comply with the requirements of corresponding laws, regulations and relevant provisions.

It can be understood that before using the technical solutions disclosed in the embodiments of the present disclosure, the user should be informed of the type, scope of use, use scenarios, etc. of the personal information involved in the present disclosure in an appropriate manner in accordance with relevant laws and regulations, and the user's authorization should be obtained.

For example, in response to receiving an active request from a user, prompt information is sent to the user, to explicitly prompt the user that the operation requested to be performed will require the acquisition and use of the user's personal information, so that the user can independently choose whether to provide the personal information to software or hardware such as an electronic device, an application, a server, or a storage medium that performs the operation of the technical solution of the present disclosure, according to the prompt information.

As an optional but non-limiting implementation, the manner of sending the prompt information to the user in response to receiving the active request from the user may be, for example, a pop-up window, and the prompt information may be presented in text in the pop-up window. In addition, the pop-up window may also carry a selection control for the user to select “agree” or “disagree” to provide the personal information to the electronic device.

It can be understood that the above process of notifying and acquiring the user's authorization is only illustrative, and does not limit the implementation of the present disclosure. Other manners that meet relevant laws and regulations may also be applied to the implementation of the present disclosure.

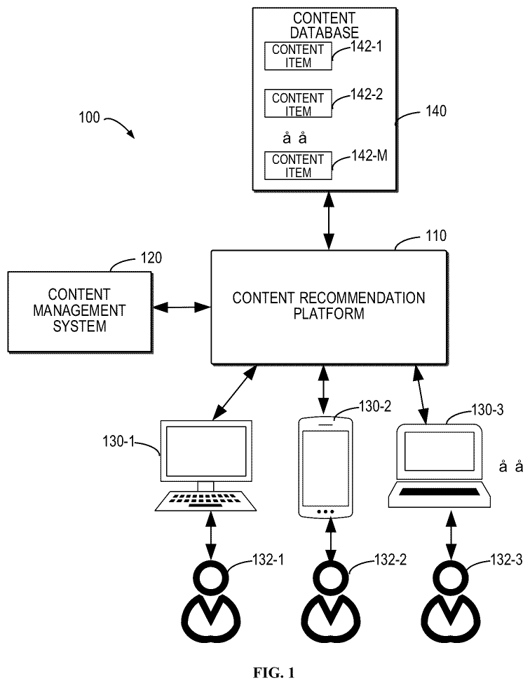

FIG. 1 shows a schematic diagram of an example environment 100 in which embodiments of the present disclosure can be implemented. One or more content providers may use a content management system 120 to manage content to be provided on a content recommendation platform 110. One or more terminal devices 130-1, 130-2, 130-3, etc. (collectively or individually referred to as the terminal device 130 for case of discussion) are associated with the content recommendation platform 110, and can access various kinds of content provided on the content recommendation platform 110.

The content recommendation platform 110 is configured to present a recommended content item in a delivery opportunity for presentation. The recommended content item to be recommended may include, for example, one or more recommended content items 122-1, 122-2, . . . , 122-M (collectively or individually referred to as the recommended content item 122 for ease of discussion) in the content database 120. As an example, the content recommendation platform 110 may be an application, a website, a web page, and other accessible resources. The terminal device 130 may be installed with an application for accessing the content recommendation platform 110, or may access the content recommendation platform 110 in a suitable manner. The terminal device 130 may access various kinds of content provided on the content recommendation platform 110 based on corresponding users 132-1, 132-2, 132-3, etc. (collectively or individually referred to as the users 132 for ease of discussion). In addition to the recommended content item for object recommendation, the content recommendation platform 110 may also provide various other content to the terminal device 130, such as content uploaded and published by other users, and the like.

The content providers may provide different content to different terminal devices 130 based on management requirements and user operations at the terminal devices 130. The content management system 120 may provide one or more specific recommended content items related to one or more recommended objects to the terminal device 130, such as one or more recommended content items 142-1, 142-2, . . . , 142-M (collectively or individually referred to as the recommended content item 142 for ease of discussion) in the content database 140. These recommended content items may include, for example, advertisements. The recommended object related to the recommended content item includes, for example, an object to which the advertisement is directed, so as to recommend a specific object to an audience. The recommended object here may include, for example, a real object, a virtual object, a service, and the like. The format of the recommended content item 142 may be in the form of a video or an image and text.

In some embodiments, the content management system 120 may determine the recommended content item 142 to be provided to one or more terminal devices 130 at least based on a request from an object provider. In the scenario of advertisement delivery, an object provider is sometimes also referred to as an advertiser.

In the environment 100, the terminal device 130 may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a TV receiver, a radio broadcast receiver, an e-book device, a game device, or any combination of the foregoing, including accessories and peripherals of these devices or any combination thereof. In some embodiments, the terminal device 130 may also support any type of user-facing interfaces (such as “wearable” circuits, etc.). The content management system 120 may be, for example, various types of computing systems/servers capable of providing computing power, including but not limited to mainframes, edge computing nodes, computing devices in cloud environments, and the like.

It should be understood that the structures and functions of respective elements in the environment 100 are only described for the purpose of example, without implying any limitation to the scope of the present disclosure.

In a case where an object is recommended in the form of a video, videos related to the recommended object are usually played as a single video. A user may need to spend a long time browsing the entire video to acquire all the recommendation information. Some users may switch video playing within a short time of video playing since they fail to know the information they are interested in, thus missing subsequent information they are interested in. As an object provider (for example, an advertiser), certain features may be highlighted in the video in a special effect way. However, since it cannot be ensured that the user can always browse the video completely when the video is delivered, such content creation may not always be seen by the user.

In an example embodiment of the present disclosure, an improved content solution is provided. According to this solution, a first video clip associated with a recommended object is played in response to a content presentation indication; a plurality of thumbnails are presented in association with the first video clip, the plurality of thumbnails being linked to a plurality of video clips associated with the recommended object, respectively; and in response to detecting a selection of a second thumbnail in the plurality of thumbnails, a second video clip associated with the second thumbnail is played while maintaining presentation of at least one of the plurality of thumbnails.

According to the embodiments of the present disclosure, a user can be allowed to quickly switch and view other video clips by means of thumbnail selection while a video is playing, thus providing more effective, convenient and attractive content browsing and interaction. In addition, in addition to dynamic videos, static thumbnails can also help to further strengthen different aspects and features of the recommended object, and help to acquire more information about the recommended object. This allows a viewer to know and anticipate the presentation of these features at once in the initial stage of browsing a video.

Some example embodiments of the present disclosure will be described below with continued reference to the drawings.

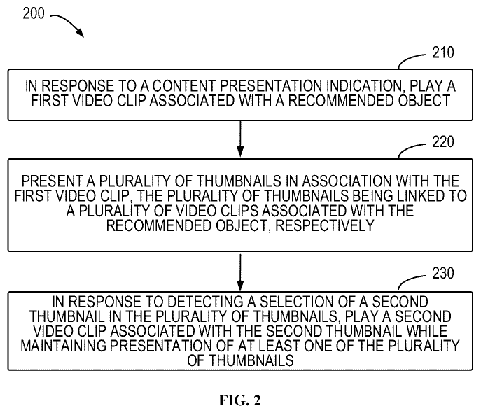

FIG. 2 shows a flowchart of a process 200 for content interaction according to some embodiments of the present disclosure. For case of discussion, the process 200 will be described with reference to the environment 100 of FIG. 1. The process 200 may be implemented in the terminal device 130 in the environment 100.

At block 210, the terminal device 130 plays a first video clip associated with a recommended object in response to a content presentation indication.

The video clip associated with the recommended object refers to the recommended content item 142 for the recommended object in the form of a video. The recommended object related to each video clip includes, for example, an object to which an advertisement is directed, so as to recommend a specific object to an audience. The object here may include, for example, a real object, a virtual object, a service, and the like. In some embodiments, such a video clip may also be referred to as a video advertisement. Generally, a video clip associated with a recommended object will focus on presenting and introducing relevant information of the recommended object, so that a viewer can learn more about the object, and then decide whether to perform other related behaviors.

In some embodiments, the presentation of a video related to the recommended object may be triggered in any application, and may be presented in any suitable user interface of the application. In some embodiments, the playing of the video clip associated with the recommended object may be based on a triggering behavior of the user or any other suitable behavior.

At block 220, the terminal device 130 presents a plurality of thumbnails in association with the first video clip. The plurality of thumbnails is linked to a plurality of video clips associated with the recommended object, respectively.

In an embodiment of the present disclosure, instead of presenting a recommended object through a single video, a plurality of video clips associated with the recommended object are provided for presentation, and the plurality of video clips is linked to corresponding thumbnails, respectively. When any of the plurality of video clips is being played, the plurality of thumbnails is presented at the same time. The plurality of thumbnails is selectable by the user, and the plurality of thumbnails are configured such that when selected, the linked video clip can be jumped to. In this way, the user can jump to the corresponding video clip for playing by selecting a certain thumbnail.

The plurality of video clips, the plurality of thumbnails, and the linking relationships between them may be provided by a video provider (which is, for example, an object provider of the recommended object, sometimes also referred to as an advertiser). For example, when the video provider provides the video content and the thumbnails, it may determine that the plurality of video clips and the plurality of thumbnails are to be uploaded, and each video clip and its corresponding thumbnail may be orchestrated. In some embodiments, the plurality of thumbnails may be superimposed and presented on a video clip being played, or the plurality of thumbnails and the video clip being played may be presented in different areas, which is not limited in the embodiments of the present disclosure, as long as the plurality of thumbnails can be presented for selection by the user while any video clip is being played. In some embodiments, the thumbnail and the played video clip may be presented in different layers of the page.

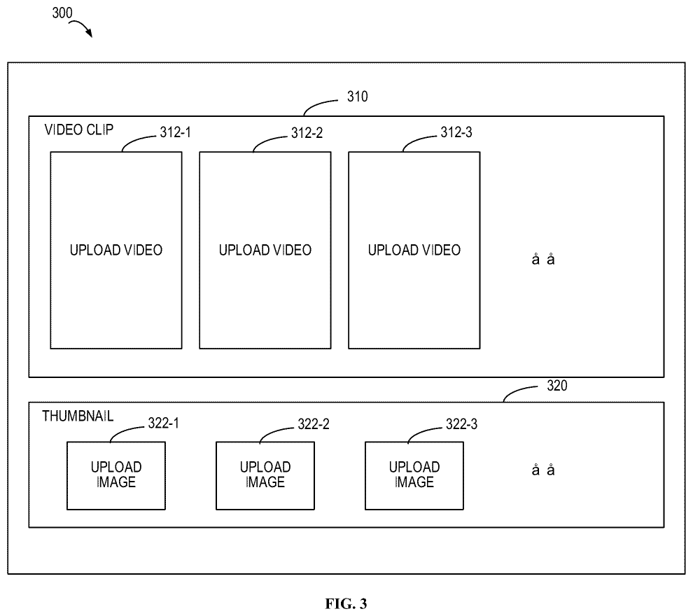

FIG. 3 shows a schematic diagram of an example page 300 for content orchestrating according to some embodiments of the present disclosure. As shown in FIG. 3, in a video content uploading area 310 of the page 300, slots 312-1, 312-2, 312-3, etc. for uploading a plurality of video clips may be provided. In a thumbnail 320 of the page 300, slots 322-1, 322-2, 322-3, etc. for uploading a plurality of thumbnails may be provided. In this way, a video provider may upload corresponding video clips to the plurality of slots, respectively.

In some embodiments, a playing order of the plurality of video clips and an arrangement order of the plurality of thumbnails are determined based on orchestrating information from the video provider. For example, in the page 300, which video clip each thumbnail is linked to may be performed according to a corresponding relationship between the video clip and the thumbnail in the slot, or may be performed by the video provider in other manners.

In some embodiments, the linking relationship between a thumbnail and a video clip may be one-to-one, that is, one thumbnail is linked to one video clip. In some embodiments, the linking relationship between a thumbnail and a video clip may be one-to-many, that is, one thumbnail is linked to multiple consecutive video clips.

In some embodiments, the playing of the first one video clip in the plurality of video clips may be based on a triggering behavior of the user or any other suitable behavior.

In some embodiments, the plurality of thumbnails includes description information of video clips to which the plurality of thumbnails is linked, respectively, including image information and text description information. In this way, in addition to the dynamic information in the video clips, the plurality of thumbnails further allows a viewer to know and anticipate the respective features of the recommended object at once in the initial stage of browsing the video.

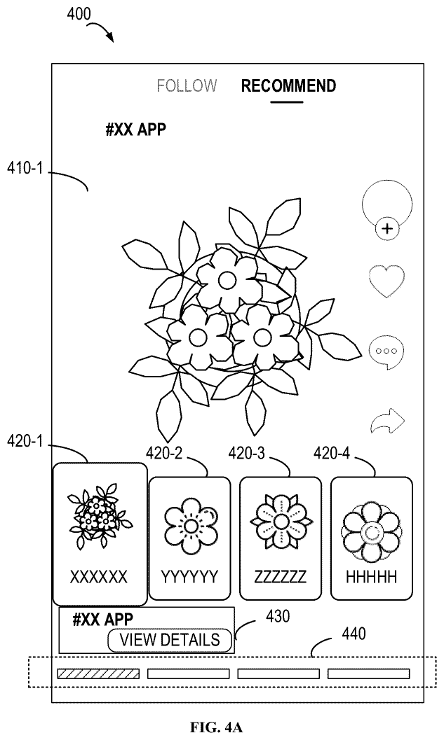

For a better understanding of the example embodiments, schematic diagrams of example content interactions in a page according to some embodiments of the present disclosure will be described below with reference to example pages shown in FIG. 4A to FIG. 4B. In these examples, a page 400 may be shown as a page or a page area of an application running on the terminal device 130. The application here is an application that supports video playing, browsing, and/or sharing. Although some operations are described in conjunction with the terminal device 130, it should be understood that these operations may be implemented by the application running on the terminal device 130. It should also be understood that the pages shown in the drawings are only examples, and various page designs may actually exist. The various graphic elements in the page may have different arrangements and different visual representations, and one or more of these elements may be omitted or replaced, and one or more other elements may also exist. The embodiments of the present disclosure are not limited in this respect.

As shown in FIG. 4A, a video clip 410-1 is played in the page 400, and a plurality of thumbnails 420-1, 420-2, 420-3, 420-4 (collectively or individually referred to as the thumbnails 420 for ease of discussion) is presented in association with the video clip 410-1. The plurality of thumbnails 420 is linked to a plurality of video clips associated with the recommended object, respectively. For example, the video clip 410-1 being played is linked to the thumbnail 420-1.

Note that the number of thumbnails and the manner in which they are presented shown in FIG. 4A are only examples, and any appropriate number of thumbnails and their corresponding video clips may be configured as needed in different content presentations, and these thumbnails may be presented in any appropriate manner.

In some embodiments, the plurality of thumbnails is presented in a tile manner, which can make it more convenient for the user to view these thumbnails. In some embodiments, depending on the number of thumbnails and the size of the page, some thumbnails may be hidden, but may be presented in an expanded manner according to user operations. For example, in the example of FIG. 4A, more thumbnails may be hidden on the left or right of the current 4 thumbnails, so that the user can view more thumbnails by swiping left and right.

At block 230, the terminal device 130, in response to detecting a selection of a second thumbnail in the plurality of thumbnails, plays a second video clip associated with the second thumbnail while maintaining presentation of at least one of the plurality of thumbnails.

The second thumbnail here may be any thumbnail selected by the user in the plurality of thumbnails. By selecting a thumbnail, the corresponding video clip can be directly jumped to for playing. As shown in FIG. 4B, a selection of the thumbnail 420-3 is detected in the page 400. Correspondingly, in the page 400, the video clip 420-1 in FIG. 4A is jumped to the video clip 410-3 corresponding to the thumbnail 420-3 for playing.

When jumping to another video clip for playing, at least one of the plurality of thumbnails previously presented is still presented in the current page. In some embodiments, some of the plurality of thumbnails previously presented may be hidden, and/or some thumbnails previously hidden may be presented with the video clip to which it is currently switched.

In some embodiments, a first thumbnail linked to the first video clip in the plurality of thumbnails is highlighted while the first video clip is played. In some embodiments, the second thumbnail is highlighted while the second video clip is played. That is, the thumbnail corresponding to the video clip currently being played is always highlighted.

Herein, “highlighting” a specific thumbnail refers to presenting the specific thumbnail more prominently in a display manner that is different from other thumbnails. For example, the highlighting manner may include enlarging a current thumbnail (as shown in the examples of FIG. 4A and FIG. 4B), superimposing a shadow on other thumbnails but not on the current thumbnail, or making the brightness of the current thumbnail brighter, superimposing other visual elements, and the like. The embodiments of the present disclosure do not further limit the specific highlighting manner.

In some embodiments, the thumbnail corresponding to the video clip being played may be highlighted for a period of time, or may be highlighted until the thumbnail of the next video clip is to be highlighted. In this way, in response to the switching of the playing of the video clip, the highlighting may be switched from one thumbnail to another thumbnail. As the playing of the video clip proceeds, the thumbnails to be highlighted are switched one by one. In this way, the playing of the video clip and the image and text information to be highlighted in each video clip may be presented to the user in conjunction.

By means of highlighting, it is easier for the user to notice the thumbnail associated with the current video clip, and more information associated with the recommended object can be acquired from the thumbnail (and may also be acquired from the corresponding text information). In addition, although other thumbnails are not highlighted, the user can still notice that there may be some important information related to the recommended object subsequently, and therefore the user may be more willing to continue watching the video, or to quickly determine whether he/she is interested in the object.

In some embodiments, the plurality of video clips may be arranged in sequence. In response to an end of playing a certain video clip (for example, the first video clip), the terminal device 130 determines whether there are more video clips after the first video clip. In response to a presence of a third video clip after the first video clip, the terminal device 130 may automatically play the third video clip. That is, in the absence of the user triggering the switching of video clips, the terminal device 130 may still play the plurality of video clips in sequence. In some embodiments, the playing of the plurality of video clips may be automatically looped. In this way, if the first video clip that has been played is the last video clip in the plurality of video clips, the terminal device 130 may play the first one video clip in the plurality of video clips.

In some embodiments, the playing order of the plurality of video clips may be the same as the arrangement order of the plurality of thumbnails. Whether the playing of the video clip is triggered by the user by selecting a thumbnail or automatically triggered due to the end of the previous video clip, the thumbnail corresponding to the video clip being played may always be highlighted.

In some embodiments, while playing the video clip and presenting the plurality of thumbnails, the terminal device 130 may further present a video clip progress bar, where the video clip progress bar indicates the number of the plurality of video clips and the video clip of the plurality of video clips that is currently being played. FIG. 4A and FIG. 4B show a video clip progress bar 440. In FIG. 4A, the video clip progress bar 440 indicates that the video clip 410-1 currently being played is the first video clip among all four video clips. In FIG. 4B, the video clip progress bar 440 indicates that the video clip 410-3 currently being played is the third video clip among all four video clips. Since there are a plurality of video clips associated with the recommended content item, by providing the video clip progress bar, the user can know in advance the number of all playable video clips or the approximate position of the video clip currently being played among all the video clips.

In some embodiments, considering that there is a plurality of video clips associated with the recommended content item, in an initial stage, in response to the content presentation indication, the terminal device 130 may pre-load at least one video clip in the plurality of video clips and the plurality of thumbnails. The at least one pre-loaded video clip may be the first one video clip, the first two video clips, or a predetermined number of video clips ranked in the top order in the plurality of video clips. The number of pre-loaded video clips may be flexibly configured according to actual applications. By pre-loading some video clips, the corresponding video clips can be quickly played when needed.

Other video clips in the plurality of video clips are loaded while the at least one video clip is being played, so as to achieve the effect of playing while downloading. In some embodiments, if the user selects a thumbnail corresponding to a subsequent video clip while playing the first one video clip or the first few video clips, the video clip corresponding to the thumbnail may be directly and quickly played in the case of pre-loading, and the corresponding video clip may be quickly downloaded for playing in the case of no pre-loading.

In some embodiments, when playing a video clip, an entrance card may be superimposed and presented on the video clip, where the entrance card indicates an access entrance to the recommended object. Via the access entrance, the playing page of the video clip may jump to a page related to the recommended object, such as a details page. In some embodiments, the video clip and the entrance card may be presented in different display layers, and the display layer of the entrance card (sometimes also referred to as a floating layer, a superimposed layer, or a tile layer) may be superimposed on the display layer of the video clip to facilitate user operations.

As shown in FIG. 4A and FIG. 4B, an entrance card 430 is superimposed and presented on a video clip being played, and the entrance card 430 includes an access entrance to the recommended object. In some implementations, the details page related to the recommended object may be jumped to by triggering the access entrance or by triggering the entrance card 430. The specific trigger manner and trigger position may be configured based on actual applications. The presentation time, presentation manner, and presentation position of the entrance card may be configured according to actual applications. The embodiments of the present disclosure are not limited in this respect.

In the above embodiments, by associating different video clips with corresponding thumbnails, the video clip to be played is located via the thumbnails. This can support flexible, efficient and convenient video switching by the user. In addition, it is also possible to present an image and text material related to the recommended object in the thumbnail, which can realize the presentation of content that exhibits the subsequent video content during the video playing process, thereby achieving the purpose of effective information presentation. This provides more effective, convenient and attractive content browsing and interaction. In the scenario of object recommendation, more features of the object to be recommended can be enhanced through the superimposition and sequential highlighting of images, so that the user can know and anticipate the presentation of these features at once while browsing the video, so as to determine his/her own interest. In addition, by combining the video content to acquire more information about the recommended object, various needs of the user for content interaction can be satisfied, and the effect of object recommendation is improved.

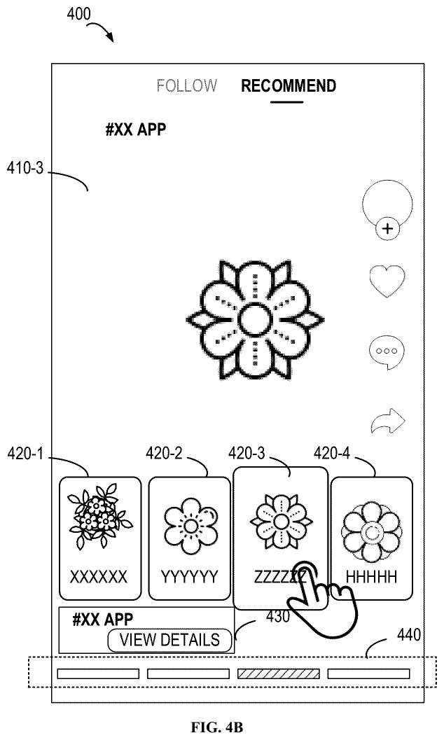

FIG. 5 shows a schematic block diagram of an apparatus 500 for content interaction according to some embodiments of the present disclosure. The apparatus 500 may be implemented in or included in the terminal device 130 and/or the content recommendation platform 110. Modules/components in the apparatus 500 may be implemented by hardware, software, firmware, or any combination thereof.

As shown, the apparatus 500 includes a first playing module 510 configured to in response to a content presentation indication, play a first video clip associated with a recommended object. The apparatus 500 further includes a thumbnail presenting module 520 configured to present a plurality of thumbnails in association with the first video clip, the plurality of thumbnails being linked to a plurality of video clips associated with the recommended object, respectively. The apparatus 500 further includes a second playing module 530 configured to in response to detecting a selection of a second thumbnail in the plurality of thumbnails, play a second video clip associated with the second thumbnail while maintaining presentation of at least one of the plurality of thumbnails.

In some embodiments, the apparatus 500 further includes: a first highlighting module configured to highlight a first thumbnail linked to the first video clip in the plurality of thumbnails while playing the first video clip; and a second highlighting module configured to highlight the second thumbnail while playing the second video clip.

In some embodiments, the plurality of video clips is arranged in sequence. The apparatus 500 further includes: a third playing module configured to in response to an end of playing the first video clip, and in response to a presence of a third video clip after the first video clip, play the third video clip; and a fourth playing module configured to in response to the first video clip being a last video clip in the plurality of video clips, play a first one video clip in the plurality of video clips.

In some embodiments, the playing order of the plurality of video clips is the same as the arrangement order of the plurality of thumbnails.

In some embodiments, the playing order of the plurality of video clips and the arrangement order of the plurality of thumbnails are determined based on orchestrating information from a video provider.

In some embodiments, the apparatus 500 further includes: a progress bar presenting module configured to present a video clip progress bar indicating a number of the plurality of video clips and a current playing video clip in the plurality of video clips.

In some embodiments, the apparatus 500 further includes: a pre-loading module configured to in response to the content presentation indication, pre-load at least one of the plurality of video clips and the plurality of thumbnails; and a synchronous loading module configured to load other video clips in the plurality of video clips while playing the at least one video clip.

In some embodiments, the plurality of thumbnails is presented in a tile manner.

In some embodiments, the plurality of thumbnails includes description information of video clips to which the plurality of thumbnails are linked, respectively.

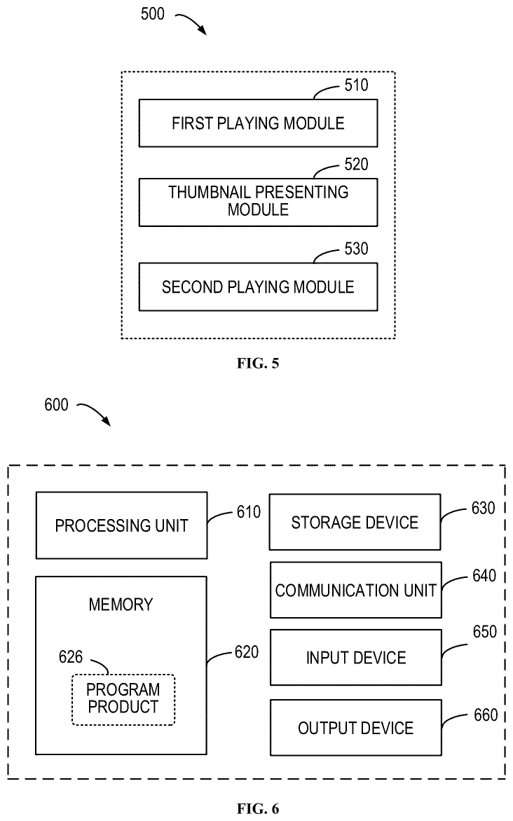

FIG. 6 shows a block diagram of an electronic device 600 in which one or more embodiments of the present disclosure can be implemented. It should be understood that the electronic device 600 shown in FIG. 6 is only illustrative, and should not constitute any limitation to the functions and scope of the embodiments described herein. The electronic device 600 shown in FIG. 6 may be used to implement the terminal device 130, the content recommendation platform 110, or the content management system 120 in FIG. 1, or the apparatus 500 in FIG. 5.

As shown in FIG. 6, the electronic device 600 is in the form of a general computing device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and can perform various processing based on programs stored in the memory 620. In a multi-processor system, multiple processing units execute computer-executable instructions in parallel to improve the parallel processing capability of the electronic device 600.

The electronic device 600 typically includes multiple computer storage media. Such media may be any available media accessible by the electronic device 600, including but not limited to volatile and non-volatile media, and removable and non-removable media. The memory 620 may be a volatile memory (for example, a register, a cache, a random-access memory (RAM)), a non-volatile memory (for example, a read-only memory (ROM), an electrically erasable programmable read-only memory (EEPROM), a flash memory), or a combination thereof. The storage device 630 may be a removable or non-removable medium, and may include a machine-readable medium, such as a flash drive, a disk, or any other medium, which may be capable of storing information and/or data (for example, training data for training) and accessible within the electronic device 600.

The electronic device 600 may further include additional removable/non-removable, volatile/non-volatile storage media. Although not shown in FIG. 6, a disk drive for reading from or writing to a removable, non-volatile disk (e.g., a “floppy disk”) and an optical disk drive for reading from or writing to a removable, non-volatile optical disk may be provided. In these cases, each drive may be connected to a bus (not shown) by one or more data media interfaces. The memory 620 may include a computer program product 626 having one or more program modules configured to perform various methods or acts of various embodiments of the present disclosure.

The communication unit 640 enables communication with other electronic devices through communication media. Additionally, the functions of the components of the electronic device 600 may be implemented in a single computing cluster or multiple computing machines that can communicate through communication connections. Thus, the electronic device 600 may operate in a networked environment using a logical connection with one or more other servers, network personal computers (PCs), or another network node.

The input device 650 may be one or more input devices, such as a mouse, a keyboard, a trackball, etc. The output device 660 may be one or more output devices, such as a display, a speaker, a printer, etc. The electronic device 600 may also communicate with one or more external devices (not shown) through the communication unit 640 as required, the external devices such as storage devices, display devices, etc., communicate with one or more devices that enable users to interact with the electronic device 600, or communicate with any device that enables the electronic device 600 to communicate with one or more other electronic devices (e.g., a network card, a modem, etc.). Such communication may be performed via an input/output (I/O) interface (not shown).

According to an example implementation of the present disclosure, a computer-readable storage medium having computer-executable instructions stored thereon is provided, where the computer-executable instructions are executed by a processor to implement the methods described above. According to an example implementation of the present disclosure, a computer program product is further provided, the computer program product is tangibly stored on a non-transitory computer-readable medium and includes computer-executable instructions, and the computer-executable instructions are executed by a processor to implement the methods described above.

Various aspects of the present disclosure are described herein with reference to the flowcharts and/or block diagrams of the method, apparatus, device, and computer program product implemented in accordance with the present disclosure. It should be understood that each block of the flowchart and/or block diagram and the combination of blocks in the flowchart and/or block diagram may be implemented by computer-readable program instructions.

These computer-readable program instructions may be provided to a processing unit of a general-purpose computer, a special-purpose computer, or other programmable data processing apparatus, thereby producing a machine, such that the instructions, when executed by the processing unit of the computer or other programmable data processing apparatus, produce an apparatus for implementing the functions/acts specified in one or more blocks of the flowchart and/or block diagram. These computer-readable program instructions may also be stored in a computer-readable storage medium. These instructions cause the computer, the programmable data processing apparatus, and/or other devices to work in a specific manner. Thus, the computer-readable medium having instructions stored thereon includes an article of manufacture, which includes instructions for implementing various aspects of the functions/acts specified in one or more blocks of the flowchart and/or block diagram.

The computer-readable program instructions may be loaded onto a computer, other programmable data processing apparatus, or other device, causing a series of operational steps to be performed on the computer, other programmable data processing apparatus, or other device to produce a computer-implemented process, such that the instructions executed on the computer, other programmable data processing apparatus, or other device implement the functions/acts specified in one or more blocks in the flowchart and/or block diagram.

The flowchart and block diagrams in the drawings show the architecture, functionality, and operation of possible implementations of systems, methods, and computer program products according to multiple implementations of the present disclosure. In this regard, each block in the flowchart or block diagram may represent a module, segment, or portion of instructions, which includes one or more executable instructions for implementing the specified logical function(s). In some alternative implementations, the functions noted in the block may occur out of the order noted in the drawings. For example, two blocks shown in succession may, in fact, can be executed substantially concurrently, or the blocks may sometimes be executed in a reverse order, depending upon the functionality involved. It will also be noted that each block of the block diagram and/or flowchart, and combinations of blocks in the block diagram and/or flowchart, can be implemented by a dedicated hardware-based system that performs the specified functions or acts, or a combination of dedicated hardware and computer instructions.

The foregoing has described implementations of the present disclosure, and the above description is illustrative, not exhaustive, and is not limited to the implementations disclosed. Many modifications and variations will be apparent to those skilled in the art without departing from the scope and spirit of the described implementations. The terms used herein are chosen in order to best explain the principles, practical applications or improvements of the technology in the market of the implementations, or to enable other ordinary skilled in the art to understand the implementations disclosed herein.

What is claimed is:

1. A method for content interaction, comprising:
in response to a content presentation indication, playing a first video clip associated with a recommended object;
presenting a plurality of thumbnails in association with the first video clip, the plurality of thumbnails being linked to a plurality of video clips associated with the recommended object, respectively; and
in response to detecting a selection of a second thumbnail in the plurality of thumbnails, playing a second video clip associated with the second thumbnail while maintaining presentation of at least one of the plurality of thumbnails.

2. The method of claim 1, further comprising:
highlighting a first thumbnail linked to the first video clip in the plurality of thumbnails while playing the first video clip; and
highlighting the second thumbnail while playing the second video clip.

3. The method of claim 1, wherein the plurality of video clips is arranged in sequence, and the method further comprises:
in response to an end of playing the first video clip,
in response to a presence of a third video clip after the first video clip, playing the third video clip; and
in response to the first video clip being a last video clip in the plurality of video clips, playing a first one video clip in the plurality of video clips.

4. The method of claim 3, wherein a playing order of the plurality of video clips is the same as an arrangement order of the plurality of thumbnails.

5. The method of claim 4, wherein the playing order of the plurality of video clips and the arrangement order of the plurality of thumbnails are determined based on orchestrating information from a video provider.

6. The method of claim 1, further comprising:
presenting a video clip progress bar indicating a number of the plurality of video clips and a current playing video clip in the plurality of video clips.

7. The method of claim 1, further comprising:
in response to the content presentation indication, pre-loading at least one of the plurality of video clips and the plurality of thumbnails; and
loading other video clips in the plurality of video clips while playing the at least one video clip.

8. The method of claim 1, wherein the plurality of thumbnails is presented in a tile manner.

9. The method of claim 1, wherein the plurality of thumbnails comprises description information of video clips to which the plurality of thumbnails is linked, respectively.

10. An electronic device, comprising:
at least one processing unit; and
at least one memory coupled to the at least one processing unit and storing instructions executable by the at least one processing unit, the instructions, when executed by the at least one
processing unit, causing the device to perform acts comprising:
in response to a content presentation indication, playing a first video clip associated with a recommended object;
presenting a plurality of thumbnails in association with the first video clip, the plurality of thumbnails being linked to a plurality of video clips associated with the recommended object, respectively; and
in response to detecting a selection of a second thumbnail in the plurality of thumbnails, playing a second video clip associated with the second thumbnail while maintaining presentation of at least one of the plurality of thumbnails.

11. The electronic device of claim 10, wherein the acts further comprise:
highlighting a first thumbnail linked to the first video clip in the plurality of thumbnails while playing the first video clip; and
highlighting the second thumbnail while playing the second video clip.

12. The electronic device of claim 10, wherein the plurality of video clips is arranged in sequence, and the acts further comprises:
in response to an end of playing the first video clip,
in response to a presence of a third video clip after the first video clip, playing the third video clip; and
in response to the first video clip being a last video clip in the plurality of video clips, playing a first one video clip in the plurality of video clips.

13. The electronic device of claim 12, wherein a playing order of the plurality of video clips is the same as an arrangement order of the plurality of thumbnails.

14. The electronic device of claim 13, wherein the playing order of the plurality of video clips and the arrangement order of the plurality of thumbnails are determined based on orchestrating information from a video provider.

15. The electronic device of claim 10, wherein the acts further comprise:
presenting a video clip progress bar indicating a number of the plurality of video clips and a current playing video clip in the plurality of video clips.

16. The electronic device of claim 10, wherein the acts further comprise:
in response to the content presentation indication, pre-loading at least one of the plurality of video clips and the plurality of thumbnails; and
loading other video clips in the plurality of video clips while playing the at least one video clip.

17. The electronic device of claim 10, wherein the plurality of thumbnails is presented in a tile manner.

18. The electronic device of claim 10, wherein the plurality of thumbnails comprises description information of video clips to which the plurality of thumbnails is linked, respectively.

19. A non-transitory computer-readable storage medium having a computer program stored thereon, wherein the computer program, when executed by a processor, performs acts comprising:
in response to a content presentation indication, playing a first video clip associated with a recommended object;
presenting a plurality of thumbnails in association with the first video clip, the plurality of thumbnails being linked to a plurality of video clips associated with the recommended object, respectively; and
in response to detecting a selection of a second thumbnail in the plurality of thumbnails, playing a second video clip associated with the second thumbnail while maintaining presentation of at least one of the plurality of thumbnails.
